(19) United States
(12) Patent Application Publication
(10) Pub. No.: US 2005/0266751 A1
(43) Pub. Date: Dec. 1, 2005

(54) Integral extrusion on fabric

(76) Inventors: Randy J. Sayers, Belding, MI (US); Kenneth A. Longstreet, Grant, MI (US)

Correspondence Address: PAUL F. DONOVAN;ILLINOIS TOOL WORKS INC, 3600 WEST LAKE AVENUE, GLENVIEW, IL, 60026, US

(21) Appl. No.: 11/189,354

(22) Filed: Jul. 26, 2005

Related U.S. Application Data
(62) Division of application No. 10/447,822, filed on May 29, 2003.
(60) Provisional application No. 60/401,724, filed on Aug. 7, 2002.
(60) Provisional application No. 60/403,946, filed on Aug. 16, 2002.

(51) Int. Cl. B32B 3/00

(52) U.S. Cl. 442/59

(57) ABSTRACT

A fabric having a plastic body integrally connected thereto by extrusion of the body onto the fabric, and a process for extruding the plastic onto the fabric.

### CROSS-REFERENCE TO RELATED APPLICATIONS

The present application claims benefit of U.S. Provisional Application 60/401,724 filed Aug. 7, 2002, and of U.S. Provisional Application 60/403,946 filed Aug. 16, 2002.

### FIELD OF THE INVENTION

The present invention relates to articles of manufacture having a stretched fabric component, such as lawn chairs and other furniture; and more particularly, the present invention relates to the suspendable web in such articles, and the manner in which the web is attached to frame components of the article.

### BACKGROUND OF THE INVENTION

Many articles of manufacture include stretched fabric components. For example, it is common to provide stretched fabric or stretched woven webs on furniture such as lawn furniture, home furniture, office seating, automotive seating, airline seating and the like. In a known process for manufacturing such articles, a ridged frame is provided with a channel therein. The fabric is attached to a sub-frame component, such as a metal or plastic extrusion, and the sub-frame member is inserted in the channel of the ridged frame.

The known procedures and structures that have been used for attaching the fabric to the sub-frame member have created difficulties and disadvantages. It is known to wrap a margin portion of the fabric at least partially around the sub-frame component, and to fasten the fabric to the sub-frame by means of rivets, screws or other fasteners. A disadvantage of this construction is that it can be time consuming and expensive to complete. Further, the strains and forces exerted on the fabric are localized at the discrete points of attachment between the fabric and sub-frame, thereby requiring reinforcement of the fabric such as with grommets, or the use of stronger fabrics.

It is also known to wrap the fabric around the sub-frame member completely, thereby encircle the sub-frame member, and to stitch the wrapped fabric to itself, thereby forming a sleeve in which the sub-frame member is received. This construction also presents disadvantages, including the time required for stitching the fabric, and the need to use additional fabric material sufficient to wrap the sub-frame member and complete the stitched seam. The additional time required in manufacture, and the need for additional fabric to form the sleeve add significant cost and expense to the completed article. When the material is stitched, needles can cause damage to fibers, weakening the fabric. Further, the frame member is loosely received in the sleeve allowing some relative relocation of the frame member and fabric. The sliding friction created can cause premature wear of the material forming the sleeve, leading to premature failure of the article. During assembly, the sub-frame member can slide completely out of the sleeve.

What is needed in the art is a procedure and construction by which fabric can be joined directly to a frame member using a minimal amount of fabric, decreasing production time and distributing forces along the length of the frame member.

### SUMMARY OF THE INVENTION

The present invention provides a process by which plastic or other material to form a frame component is extruded directly on to a margin portion adjacent an edge of a fabric web, and bonded with the fabric web.

In one form thereof, the present invention provides a suspendable web with a fabric having an edge and a margin portion adjacent the edge, and a continuous plastic body bonded to the margin portion by extrusion of the plastic onto the fabric.

In another form thereof, the present invention provides a method for forming a suspendable web. The method has steps of providing a fabric having at least one edge and at least one margin portion adjacent the at least one edge; providing an extruder and plastic to be extruded by the extruder; moving the margin portion through the extruder; extruding plastic onto the at least one margin portion to form a body along the edge; and cooling the extruded plastic to bond the plastic body to the fabric.

In still another form thereof, the present invention provides a suspendable web for suspension in a frame. A fabric has first and second edges on opposite sides of the fabric, and first and second margins adjacent the first and second edges, respectively. The fabric includes a plurality of fibers. A first continuous plastic body is bonded to the first margin portion by extrusion of the plastic onto the fabric, with plastic material of the first plastic body embedded between fibers of the fabric. A second continuous plastic body is bonded to the second margin portion by extrusion of the plastic onto the fabric, with plastic material of the second plastic body embedded between fibers of the fabric.

An advantage of the present invention is providing a process by which an extruded frame member can be attached directly to a fabric web, thereby integrally bonding the frame member and fabric together.

Another advantage of the present invention is providing an integral frame and fabric assembly that distributes forces along the length of the frame, eliminating localization of the forces at connecting points between the fabric and frame.

Still another advantage of the present invention is providing a frame and fabric construction reducing the amount of fabric material required.

A still further advantage is providing a process by which an extruded frame member can be attached to a fabric web with reduced manufacturing time and expense.

A further advantage of the present invention is providing a frame and fabric construction that seals the fabric edge, minimizing the potential for fraying.

Other features and advantages of the invention will become apparent to those skilled in the art upon review of the following detailed description, claims and drawings in which like numerals are used to designate like features.

### BRIEF DESCRIPTION OF THE DRAWINGS

FIG. 1 is a plan view of an extrusion process in accordance with the present invention;

FIG. 2 is a fragmentary cross sectional view of the equipment and process shown in FIG. 1;

FIG. 3 is an end elevational view of the apparatus shown in FIGS. 1 and 2, with the fabric and extrusion thereon shown in cross section;

FIG. 4 is an elevational view of equipment for a modified form of a process for attaching an extruded frame to a fabric web in accordance with the present invention;

FIG. 5 is an elevational view, in partial cross section, of the apparatus shown in FIG. 4, showing the side opposite the side shown in FIG. 4;

FIG. 6 is an end elevational view of a portion of the apparatus shown in FIGS. 4 and 5, with the fabric and extrusion thereon shown in cross section;

FIG. 7 is an enlarged cross-sectional view of the fabric and extrusion thereon; and

FIG. 8 is a plan view of a further extrusion process in accordance with the present invention.

Before the embodiments of the invention are explained in detail, it is to be understood that the invention is not limited in its application to the details of construction and the arrangements of the components set forth in the following description or illustrated in the drawings. The invention is capable of other embodiments and of being practiced or being carried out in various ways. Also, it is understood that the phraseology and terminology used herein are for the purpose of description and should not be regarded as limiting. The use herein of “including” and “comprising” and variations thereof is meant to encompass the items listed thereafter and equivalents thereof, as well as additional items and equivalents thereof.

### DETAILED DESCRIPTION OF THE PREFERRED EMBODIMENT

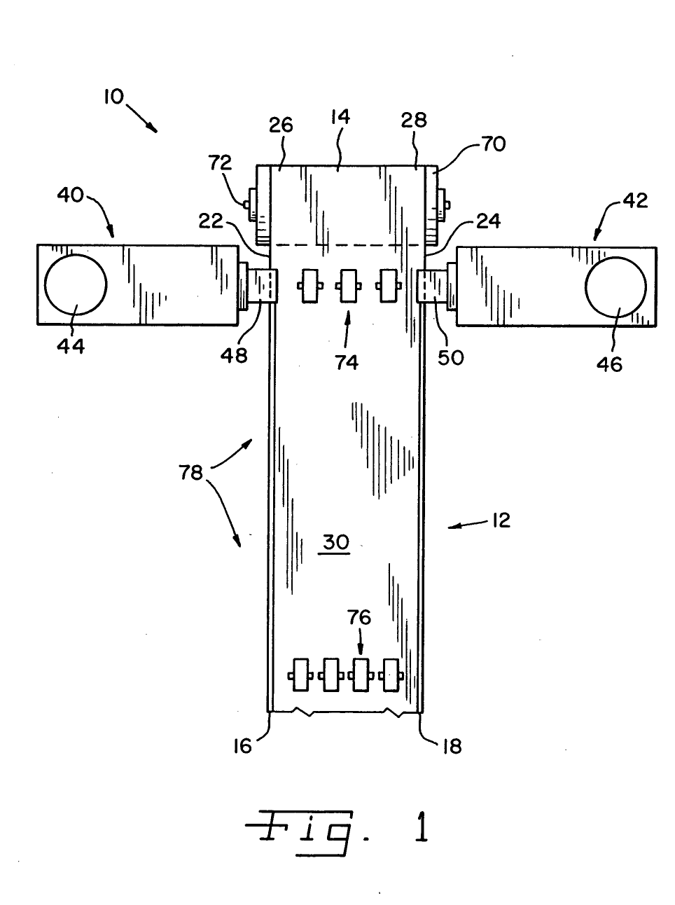

Referring now more specifically to the drawings and to FIG. 1 in particular, numeral 10 designates an extrusion process for creating a suspendable web 12, each in accordance with the present invention. Suspendable web 12 is suitable for suspension in a frame, as known to those skilled in the art, and can be used for the manufacture of lawn furniture, office furniture and other structures requiring suspension of a material web between supporting members.

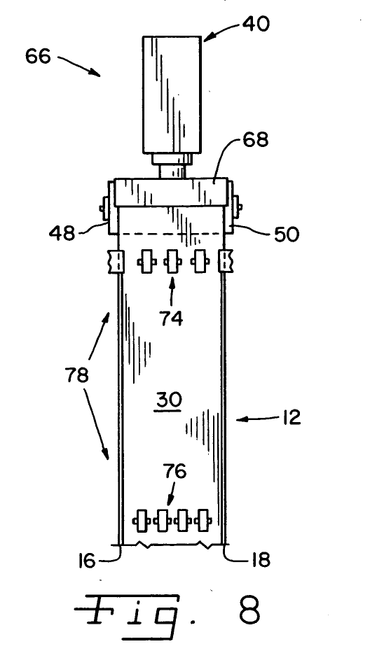

Suspendable web 12 includes a fabric 14 and first and second bodies 16 and 18 adhered integrally thereto. Fabric 14 can be of any material suitable for the final application and use for suspendable web 12. Woven cloth fabrics of both natural and man-made fibers 20 are suitable for fabric 14, as are other synthetic fabrics of plastic or the like. Fibers 20 can be provided in a number of different weave patterns, and the simple weave illustrated in FIG. 7 is merely one example thereof, and should not be viewed as limiting of the present invention in any manner.

Fabric 14 has first and second fabric edges 22 and 24, respectively, and first and second margin portions 26 and 28 adjacent edges 22 and 24, respectively. First and second bodies 16 and 18 are adhered to fabric 14 along first and second margin portions 26 and 28 respectively. The width of fabric 14 is selected for the final use of suspendable web 12, and the full width of fabric 14 is used, without the need for extra width of fabric 14 to wrap bodies 16 and 18. Fabric 14 has opposed surfaces 30 and 32, and margin portions 26 and 28 extend inwardly from edges 22 and 24, respectively, on each surface 30 and 32. Thus, first margin portion 26 extends inwardly from first edge 22 on both surfaces 30 and 32, and second margin portion 28 extends inwardly from second edge 24 on both surfaces 30 and 32.

First and second bodies 16 and 18 are made of extrudable material, such as plastic, suitable for the final application and use of suspendable web 12. Bodies 16 and 18 encapsulate edges 22 and 24, respectively, with each body 16 and 18 adhered to opposed first and second surfaces 30 and 32 of margins 26 and 28, respectively.

Extrusion process 10 includes first and second extruders 40 and 42, respectively, for extruding first and second bodies 16 and 18 on fabric 14 simultaneously. Extruders 40 and 42 include hoppers 44 and 46, respectively, for receiving suitable plastic resin material to form extruded plastic bodies 16 and 18. Extruders 40 and 42 further include cross head dies 48 and 50, respectively, which deposit the molten plastic material onto margins 26 and 28, and form bodies 16 and 18, respectively.

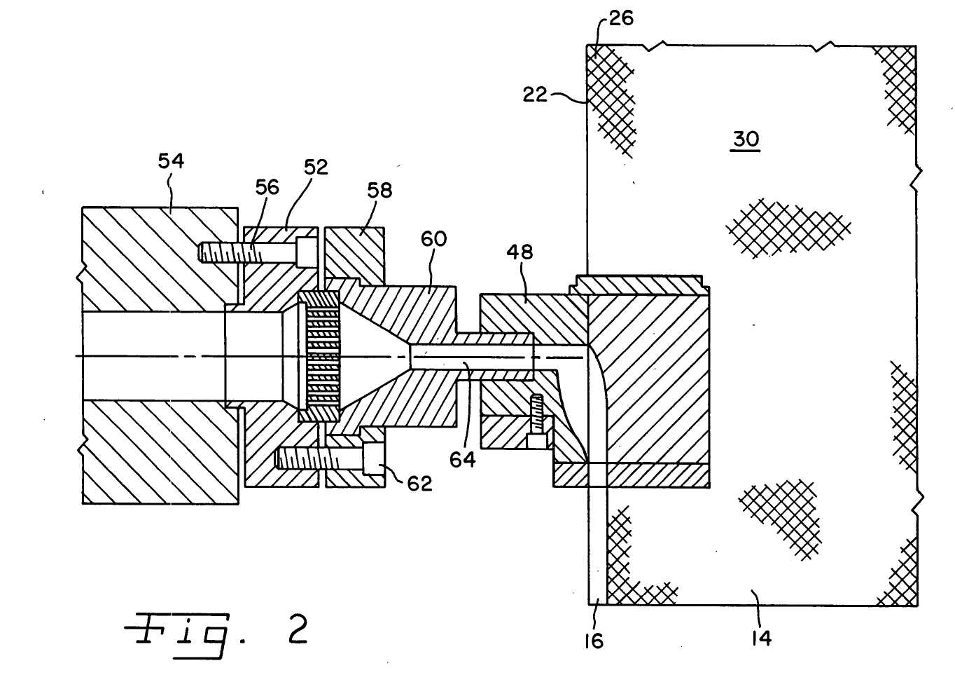

Extruders 40 and 42 can be of a variety of different designs known to those skilled in the art, one of which is shown in FIG. 2. An inner adaptor 52 is held to an extruder heating assembly 54 by suitable fasteners, such as bolts 56. A clamp ring 58 secures an outer adaptor 60 to inner adaptor 52. Clamp ring 58 can be secured to inner adapter 52 by bolts 62. Outer adaptor 60 is joined to cross head die 48. The assembly just described, along with cross head die 48, defines an extrusion channel 64 through which hot, molten plastic flows from heating assembly 54 to fabric 14, for deposit on first margin portion 26 via cross head die 48.

It should be understood that extruder 40 described herein is merely one suitable extruder assembly useful for the present invention, and other extruders and extrusion processes can be used for depositing body 16 along margin portion 26. Further, while extruders 40 and 42 are shown in direct opposition to each other, for simultaneously applying plastic bodies 16 and 18 to first and second margin portions 26 and 28, respectively, extruders for the present process can be otherwise positioned with respect to each other. Further, first one body can be applied and subsequently a second body can be applied, in successive rather than simultaneous steps. Alternatively, only one of first and second margin portions 26 and 28 may receive thereon a plastic body 16 or 18, in some applications and uses of the present invention, with the other margin portion 26, 28 receiving no plastic body 16, 18. It should be understood also that although shown the same, extruders 40 and 42 could be different. For example, in some applications of the present invention it may be desirable to provide bodies 16 and 18 of different shapes or sizes.

FIG. 8 illustrates an extrusion process 66 using a cross head dies 48 and 50 with a single extruder 40 and a hot manifold 68 to extrude simultaneously along both first edge 22 and second edge 24. Those skilled in the art will understand that a variety of other equipment arrangements also can be used advantageously in the present invention.

In the process of the present invention, advantageously fabric 14 is supplied on a roll 70 held on an unwind stand 72. In known manner, servo-drive rollers 74 and pull rollers 76 are provided for pulling fabric 14 from roll 70. Rollers 74 and 76 stretch fabric 14 as required and pull fabric 14 through cross head dies 48 and 50 at a suitable speed for the application via extrusion of plastic bodies 16 and 18 thereon. A cooling area 78, which can be an extended conveying area, is provided downstream of extruders 40 and 42, allowing for solidification of the molten plastic bodies 16 and 18 deposited on fabric 14. Cooling area 78 can provide active cooling in the way of a cooled medium to which heat is transferred, or passive cooling can occur, with the heat generated during extrusion being simply dissipated to the ambient environment

As is known to those skilled in the art, plastic resin is heated in extruders 40 and 42 and supplied as a molten fluid to cross head dies 48 and 50. Advantageously, materials for fabric 14 and first and second plastic bodies 16 and 18 are selected, and a temperature is provided in cross head dies 48 and 50 such that first and second margin portions 26 and 28 are softened as the extrusion process occurs. Margins 25 and 28 can be heated directly from a source of heat, or indirectly from the residual heat in dies 48 and 50 and/or from contact with the molten plastic deposited thereon. By softening margin portions 26 and 28, as plastic bodies 16 and 18 are deposited thereon, greater adherence is provided between bodies 16 and 18 and fabric 14.

It should be understood that dies 48 and 50 can be used to provide a variety of different cross sectional shapes for bodies 16 and 18, which may be the same on a particular fabric 14, or different body configurations can be applied for plastic bodies 16 and 18.

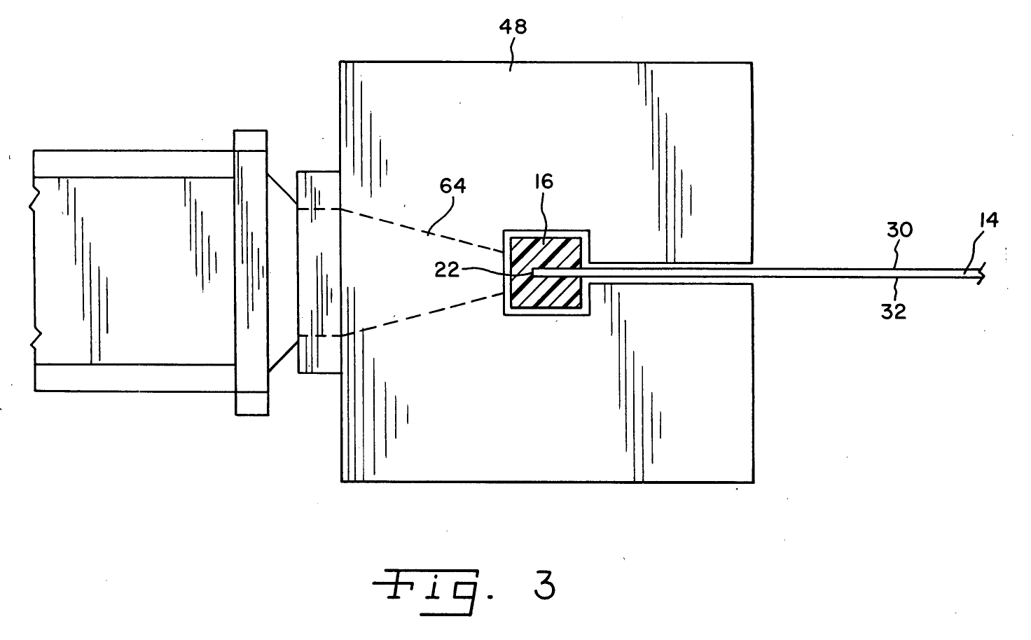

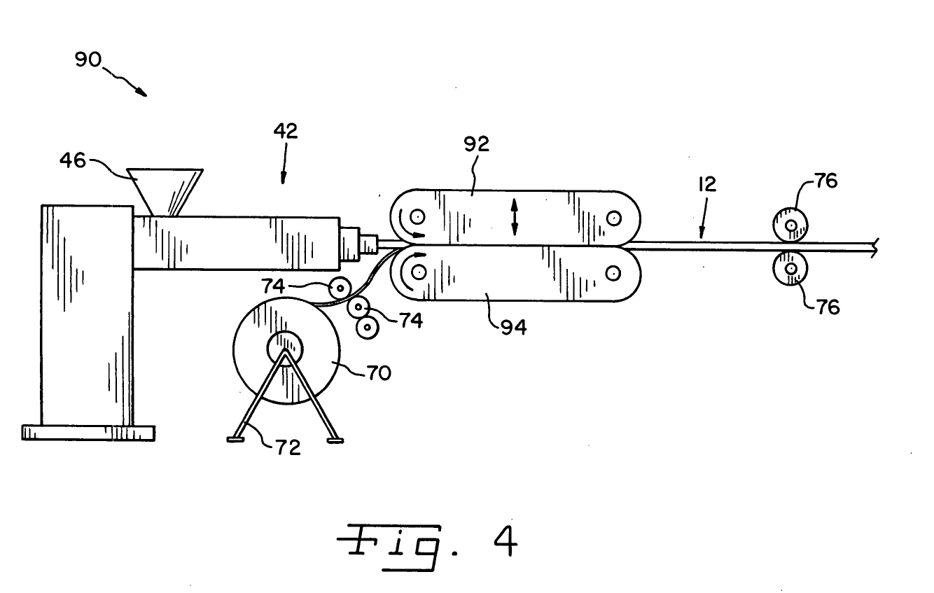

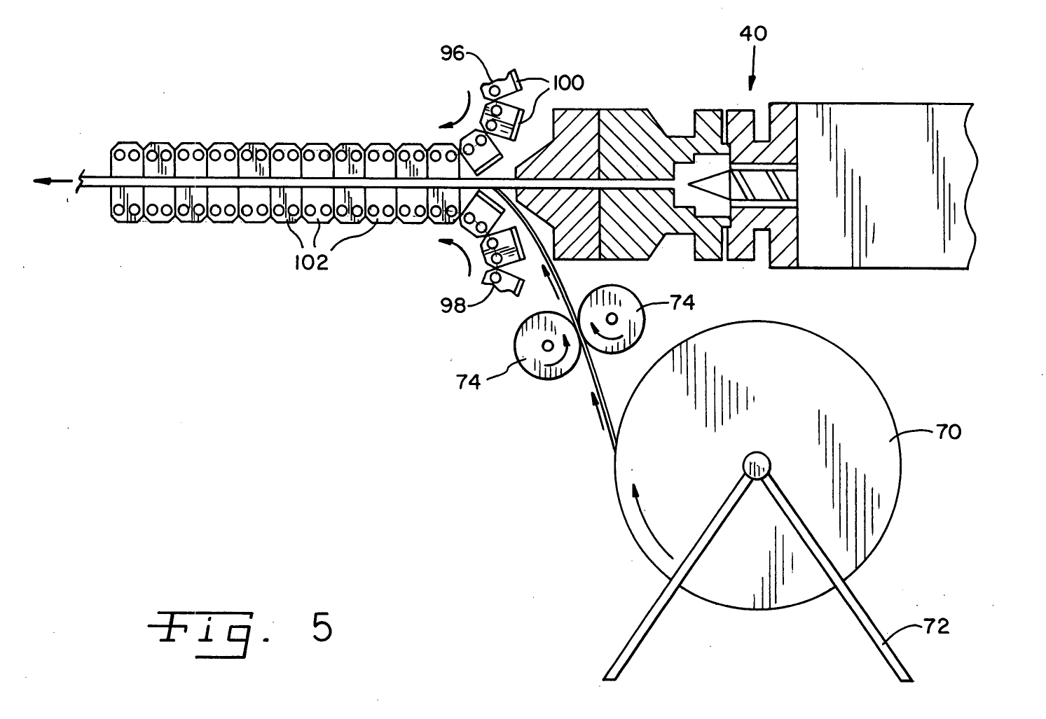

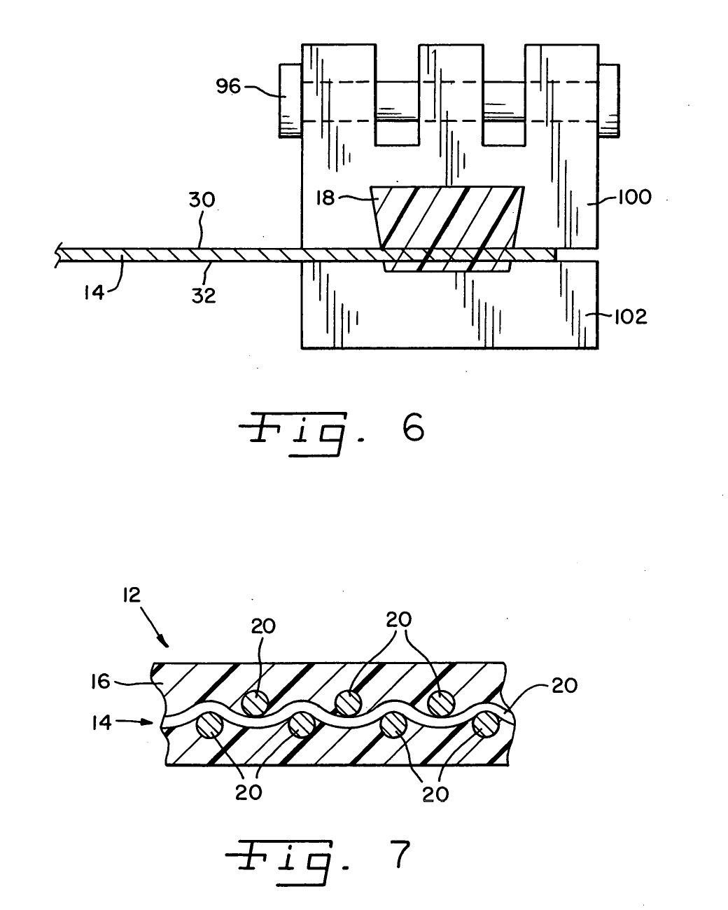

As illustrated in FIGS. 1-3, simple flow forming extrusion processes can be used. However, advantageously, pressure-forming dies also can be used. FIG. 4 illustrates a continuous pressure die forming process 90 in which upper and lower continuous die forms 92 and 94 are provided. Each continuous die form 92, 94 includes an endless chain 96, 98, respectively, having individual die segments 100, 102, respectively, thereon. With the use of pressure-forming dies, the molten plastic for bodies 16 and 18 can be forced into the interstices between fibers 20. Upon hardening of bodies 16 and 18, a mechanical lock is created between fabric 14 and plastic bodies 16, 18, as generally depicted in FIG. 7.

In the use of the process of the present invention, drive rollers 74 remove fabric 14 from fabric supply roll 70, and together with pull rollers 76 introduce margin portions 26 and 28 to extruders 40 and 42. Molten plastic is applied as streams on opposite first and second surfaces 30, 32 of first and second margin portions 26 and 28. If pressure forming is used, the segmented pressure-forming dies are forced onto the streams of molten plastic, to shape bodies 16 and 18 as defined by die segments 100, 102. Pressure is applied on the plastic extrusion and fabric to create the mechanical bond by forcing molten plastic into the open weave of fabric 14. Further, the heat from the extrusion process softens the material of margins 26 and 28, and the pressure from pressure forming dies 92, 94 further enhances bonding between the molten plastic and fibers 20. Bodies 16 and 18 are cooled along cooling area 78.

The process for forming an integral extrusion on fabric, and the fabric formed thereby of the present invention provide improved suspension webs for use in furniture and other similar articles. Production steps are reduced and costs minimized, with fewer steps required. Fabric 14 can be less wide than with previous processes, since it is no longer necessary to use the margin of the fabric to wrap a sub-frame. Therefore, material requirements are reduced, costs lessened. A stronger, less expensive suspendable web is provided.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A suspendable web for suspension in a frame, comprising:
a fabric having an edge and a margin portion adjacent said edge; and
a continuous plastic body bonded to said margin portion by extrusion of said plastic onto said fabric.

2. The suspendable web of claim 1, said fabric having two said edges and two said margin portions, and two said continuous plastic bodies, and a different one of said plastic bodies bonded to each of said margin portions by extrusion onto said fabric.

3. The suspendable web of claim 1, said fabric having interstices filled by said plastic.

4. The suspendable web of claim 1, said fabric being plastic.

5. A method for forming a suspendable web, said method comprising steps of:
providing a fabric having at least one edge and at least one margin portion adjacent the at least one edge;
providing an extruder and plastic to be extruded by the extruder;
moving the at least one margin portion through the extruder;
extruding plastic onto the at least one margin portion to form a body along the at least one edge; and
cooling the extruded plastic to bond the plastic body to the fabric.

6. The method of claim 5, said step of extruding including heating the plastic to a temperature sufficient for softening material forming the fabric, and extruding the plastic at the temperature.

7. The method of claim 5, including heating the margin portion to soften fibers in the web.

8. The method of claim 5, including a second step of extruding for extruding a second body on a second margin portion of the fabric along a second edge of the fabric opposite the first mentioned edge.

9. The method of claim 8, said first and second extruding steps performed simultaneously.

10. The method of claim 5, said step of extruding including applying streams of said plastic on opposite surfaces of said margin portion.

11. The method of claim 10, including pressing said applied streams of plastic with a die, and forcing extruded plastic into spaces around fibers of the fabric.

12. The method of claim 10, including extruding a second body on a second margin portion of the fabric along a second edge of the fabric opposite the first mentioned edge.

13. The method of claim 12, including heating the margin portions to soften fibers in the web.

14. The method of claim 12, said steps of extruding including heating the plastic to a temperature sufficient for softening fibers forming the fabric, and extruding the plastic at the temperature.

15. The method of claim 12, said second step of extruding including applying streams of said plastic on opposite surfaces of the second margin portion.

16. The method of claim 15, including pressing all said applied streams of plastic with dies, and forcing extruded plastic into spaces around fibers of the fabric.

17. The method of claim 15, said steps of extruding including heating the plastic to a temperature sufficient for softening material forming the fabric, and extruding the plastic at the temperature.

18. The method of claim 17, including pressing all said applied streams of plastic, and forcing extruded plastic into spaces around fibers of the fabric.

19. The method of claim 17, said first and second extruding steps performed simultaneously.

20. The method of claim 19, including pressing all said applied streams of plastic, and forcing extruded plastic into spaces around fibers of the fabric.

21. A suspendable web for suspension in a frame comprising:
a fabric having first and second edges on opposite sides of the fabric, and first and second margins adjacent said first and second edges, respectively, said fabric including a plurality of fibers; and
a first continuous plastic body bonded to said first margin portion by extrusion of said plastic onto said fabric, with plastic material of said first plastic body embedded between fibers of said fabric; and
a second continuous plastic body bonded to said second margin portion by extrusion of said plastic onto said fabric, with plastic material of said second plastic body embedded between fibers of said fabric.

22. The suspendable web of claim 21, said first plastic body and said second plastic body encapsulating said first edge and said second edge, respectively.

23. The suspendable web of claim 21, said fabric being plastic.
